(19) United States
(12) Patent Application Publication
(10) Pub. No.: US 2018/0295573 A1
(43) Pub. Date: Oct. 11, 2018

(54) ADAPTIVE TARGET WAKE TIME SCHEDULING

(71) Applicant: QUALCOMM Incorporated, San Diego, CA (US)

(72) Inventors: Ravi Gidvani, Fremont, CA (US); Sandip HomChaudhuri, San Jose, CA (US); Zhanfeng Jia, Belmont, CA (US); BadriSrinivasan Sampathkumar, Fremont, CA (US); Alireza Raissinia, Monte Sereno, CA (US); Srinivas Katar, Fremont, CA (US); Madhan Jaganathan, Cupertino, CA (US); Xiaolong Huang, San Jose, CA (US)

(21) Appl. No.: 15/481,106

(22) Filed: Apr. 6, 2017

(51) Int. Cl. H04W 52/02; H04W 72/04

(52) U.S. Cl. CPC H04W 52/0216; H04W 72/0446; H04W 88/08; H04W 52/0235; H04W 52/0245

(57) ABSTRACT

Methods, systems, and devices for wireless communication are described. An access point (AP) may communicate with a plurality of stations in a basic service set (BSS) according to a target wakeup time (TWT) slot duration. The AP may identify one or more congestion or interference factors for the BSS. In some cases, the AP may identify a congestion score based at least in part on at least one of the one or more congestion factors from one or more stations that can be part of its own BSS, and an interference score based at least in part on at least one of the one or more interference factors form one or more stations that are not part of AP's BSS. In some cases, the AP may modify the TWT slot duration based at least in part on the congestion score and the interference score.

### BACKGROUND

The present disclosure relates generally to wireless communication, and more specifically to adaptive target wake time scheduling.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (i.e., Institute of Electrical and Electronics Engineers (IEEE) 802.11) network may include an access point (AP) that may communicate with one or more stations (STAs) or mobile devices. The AP may be coupled to a network, such as the Internet, and may enable a mobile device to communicate via the network (or communicate with other devices coupled to the AP). A wireless device may communicate with a network device bi-directionally. For example, in a WLAN, a STA may communicate with an associated AP via DL and UL. The DL (or forward link) may refer to the communication link from the AP to the STA, and the UL (or reverse link) may refer to the communication link from the STA to the AP.

In some cases, an AP communicating with a number of STAs may use techniques that enable power saving for the wireless devices in the WLAN. These techniques may include some WLANs using a scheduled access where an AP assigns target wakeup time (TWT) groups for one or more STAs. The AP may schedule periods of communication and sleep for the STAs that the AP serves. The STAs of the TWT group may then wake up according to the TWT to access the medium. STAs that are awake to communicate with the AP may rotate based on the assigned TWT group. In certain wireless environments (e.g., high density wireless environments), for example in the presence of a large number of STAs assigned to a TWT group within a basic service set (BSS), there may be a significant number of collisions between the timing of TWTs for the BSS and traffic external to the BSS, for example from stations in other BSSs (OBSSs), leading to inefficient medium utilization.

### SUMMARY

The described techniques relate to improved methods, systems, devices, or apparatuses that support adaptive target wake time scheduling. Generally, the described techniques provide for modulating target wake time slots to reduce number of collisions.

An access point (AP) may use a combination of broadcast, multicast, or unicast target wakeup time (TWT) procedures to communicate with multiple stations (STAs) within a basic service set (BSS). For example, the AP may use TWT procedures to enable increased power savings and efficiency. The AP may modify a duration of TWT slots and transmit the indication to one or more STAs. The one or more STAs may include all or a subset of STAs of the BSS. Dynamically adjusting the duration of the TWT slot duration depending on a number of factors may avoid collisions between TWT periods, increasing efficient use of the medium.

The factors considered by the AP to modify the TWT slot duration may include interference factors, or congestion factors, or both, for the BSS. Interference factors may be based on traffic within the BSS of the AP, while congestion factors may be based on traffic outside the BSS, such as in one or more neighboring other BSSs (OBSSs), or based on both BSS and OBSS measurement. A quantification score (e.g., a quantification metric) may be determined based on an interference score identified from the interference factors, or a congestion score identified from the congestion factors, or both an interference score and a congestion score. The AP may signal a modified TWT slot duration to the STAs of the BSS as the TWT slot durations are updated and modified.

A method of wireless communication is described. The method may include communicating with a plurality of stations in a BSS according to a TWT slot duration, identifying one or more congestion or interference factors for the BSS, modifying the TWT slot duration based at least in part on the one or more congestion or interference factors, and communicating with the plurality of stations in the BSS according to the modified TWT slot duration.

An apparatus for wireless communication is described. The apparatus may include means for communicating with a plurality of stations in a BSS according to a TWT slot duration, means for identifying one or more congestion or interference factors for the BSS, means for modifying the TWT slot duration based at least in part on the one or more congestion or interference factors, and means for communicating with the plurality of stations in the BSS according to the modified TWT slot duration.

Another apparatus for wireless communication is described. The apparatus may include a processor, memory in electronic communication with the processor, and instructions stored in the memory. The instructions may be operable to cause the processor to communicate with a plurality of stations in a BSS according to a TWT slot duration, identify one or more congestion or interference factors for the BSS, modify the TWT slot duration based at least in part on the one or more congestion or interference factors, and communicate with the plurality of stations in the BSS according to the modified TWT slot duration.

A non-transitory computer readable medium for wireless communication is described. The non-transitory computer-readable medium may include instructions operable to cause a processor to communicate with a plurality of stations in a BSS according to a TWT slot duration, identify one or more congestion or interference factors for the BSS, modify the TWT slot duration based at least in part on the one or more congestion or interference factors, and communicate with the plurality of stations in the BSS according to the modified TWT slot duration.

In some examples of the method, apparatus, and non-transitory computer-readable medium described above, modifying the TWT slot duration based at least in part on the one or more congestion or interference factors comprises: determining a quantification score based at least in part on the one or more congestion or interference factors. Some examples of the method, apparatus, and non-transitory computer-readable medium described above may further include processes, features, means, or instructions for modifying the TWT slot duration based at least in part on the determined quantification score.

In some examples of the method, apparatus, and non-transitory computer-readable medium described above, determining the quantification score based at least in part on the one or more congestion or interference factors comprises: identifying a congestion score based at least in part on at least one of the one or more congestion factors. Some examples of the method, apparatus, and non-transitory computer-readable medium described above may further include processes, features, means, or instructions for identifying an interference score based at least in part on at least one of the one or more interference factors. Some examples of the method, apparatus, and non-transitory computer-readable medium described above may further include processes, features, means, or instructions for determining the quantification score based at least in part on the congestion score and the interference score.

In some examples of the method, apparatus, and non-transitory computer-readable medium described above, determining the quantification score based at least in part on the one or more congestion or interference factors further comprises: identifying a first weighting factor for the congestion score. Some examples of the method, apparatus, and non-transitory computer-readable medium described above may further include processes, features, means, or instructions for identifying a second weighting factor for the interference score. Some examples of the method, apparatus, and non-transitory computer-readable medium described above may further include processes, features, means, or instructions for determining the quantification score based at least in part on the first weighting factor applied to the congestion score and the second weighting factor applied to the interference score.

In some examples of the method, apparatus, and non-transitory computer-readable medium described above, modifying the TWT slot duration based at least in part on the determined quantification score comprises: identifying a TWT slot duration value based at least in part on a table of a plurality of TWT slot duration values corresponding to a plurality of quantification scores. Some examples of the method, apparatus, and non-transitory computer-readable medium described above may further include processes, features, means, or instructions for updating the TWT slot duration to use to communicate with the plurality of stations based at least in part on the identified TWT slot duration value.

In some examples of the method, apparatus, and non-transitory computer-readable medium described above, modifying the TWT slot duration based at least in part on the determined quantification score comprises: identifying that the determined quantification score exceeds a first threshold. Some examples of the method, apparatus, and non-transitory computer-readable medium described above may further include processes, features, means, or instructions for selecting a reduced TWT slot duration.

In some examples of the method, apparatus, and non-transitory computer-readable medium described above, modifying the TWT slot duration based at least in part on the determined quantification score comprises: identifying that the determined quantification score exceeds a second threshold. Some examples of the method, apparatus, and non-transitory computer-readable medium described above may further include processes, features, means, or instructions for selecting a TWT slot duration to be zero.

In some examples of the method, apparatus, and non-transitory computer-readable medium described above, the one or more congestion factors comprise a first number of the plurality of stations of the BSS, a second number of the plurality of stations of the BSS supporting a TWT mode of operation, or a comparison between the first number and the second number, or a depth of transmit queue of the AP, or a number of transmit queue of the AP, or a combination thereof.

In some examples of the method, apparatus, and non-transitory computer-readable medium described above, the one or more interference factors comprise a received signal strength, or a number of detected stations of one or more OBSSs, or a number of detected access point of the one or more OBSSs, or a traffic level for the one or more OBSSs, or a number of stations of the one or more OBSSs that support a TWT mode of operation, or a combination thereof.

Some examples of the method, apparatus, and non-transitory computer-readable medium described above may further include processes, features, means, or instructions for transmitting an indication of the modified TWT slot duration to the plurality of stations of the BSS.

Some examples of the method, apparatus, and non-transitory computer-readable medium described above may further include processes, features, means, or instructions for transmitting the indication of the modified TWT slot duration in a management frame during a TWT service period.

In some examples of the method, apparatus, and non-transitory computer-readable medium described above, communicating with the plurality of stations in the BSS according to the modified TWT slot duration comprises: communicating with a first set of the plurality of stations in the BSS during one or more TWT slots of a TWT service period, the one or more TWT slots having the modified TWT slot duration. Some examples of the method, apparatus, and non-transitory computer-readable medium described above may further include processes, features, means, or instructions for communicating with a second set of the plurality of stations in the BSS during the TWT service period and outside the one or more TWT slots.

In some examples of the method, apparatus, and non-transitory computer-readable medium described above, communicating with the plurality of stations in the BSS according to the modified TWT slot duration comprises: transmitting data to a first set of the plurality of stations in the BSS during a downlink portion of a TWT slot having the modified TWT slot duration. Some examples of the method, apparatus, and non-transitory computer-readable medium described above may further include processes, features, means, or instructions for receiving data from the first set of the plurality of stations in the BSS during an uplink portion of the TWT slot.

### BRIEF DESCRIPTION OF THE DRAWINGS

FIG. 1 illustrates an example of a system for wireless communication that supports adaptive target wake time scheduling in accordance with aspects of the present disclosure.

FIG. 2 illustrates an example of a wireless communications system for adaptive target wake time scheduling allocation in accordance with various aspects of the present disclosure.

FIG. 3 illustrates an example of a TWT SP configuration for adaptive target wake time scheduling allocation in accordance with various aspects of the present disclosure.

FIGS. 4A through 4C illustrate examples of TWT configurations for adaptive target wake time scheduling allocation in accordance with various aspects of the present disclosure.

FIG. 5 illustrates an example of a process flow for a system that supports adaptive target wake time scheduling allocation in accordance with various aspects of the present disclosure.

FIGS. 6 through 8 show block diagrams of a device that supports adaptive target wake time scheduling in accordance with aspects of the present disclosure.

FIG. 9 illustrates a block diagram of a system including an AP that supports adaptive target wake time scheduling in accordance with aspects of the present disclosure.

FIGS. 10 through 12 illustrate methods for adaptive target wake time scheduling in accordance with aspects of the present disclosure.

### DETAILED DESCRIPTION

In some wireless communication systems, an access point (AP) may use target wake time (TWT) procedures to schedule communications for multiple stations (STAs) in a basic service set (BSS). The TWT procedures may enable increased power savings and efficiency by enabling scheduled periods of sleep and communication. That is, a TWT procedure may enable the AP to indicate to specific STAs whether they should power up to communicate during an “on” duration (e.g., a TWT slot duration). The indicated STAs may include all or a subset of STAs of the BSS (e.g., a BSS may include both STAs that are capable of operating using TWT procedures, as well as legacy STAs that lack such capabilities). Dynamically adjusting the duration of the “on” duration (e.g., the TWT slot duration) depending on a number of interference or congestion factors may avoid collisions between TWT periods, increasing efficient use of the medium.

In some examples, the AP may assess a number of factors associated with its environment to quantify a congestion level that may indicate an amount of traffic within the BSS. In some examples, the amount of traffic within the BSS can justify a need for a TWT mode of operation. The AP may determine a congestion score using the congestion level, for example by assigning weights to a number of factors for stations of the BSS. The factors may include a first number of STAs supporting the TWT mode of operation and an amount of traffic from such STAs, a second number of STAs not supporting the TWT mode of operation and an amount of traffic from these non-TWT stations, a ratio between the first number of STAs and the second number of STAs, a depth of the transmit queue (e.g., an amount of data in the transmit buffer) of the AP, a number of transmit queues of the AP, or a combination of these.

In some examples, the AP can assess its environment to quantify an interference level indicating an amount of other BSS (OBSS) traffic that can justify the need for a non-TWT or reduced TWT mode of operation. In some examples, the AP may assess its environment to determine whether it should disable the TWT mode of operation. For example, the interference level may indicate a number of STAs within one or more OBSSs that support a reduced TWT mode of operation, or does not support the TWT mode of operation. The AP may determine an interference score using the interference level, for example by assigning weights to factors like energy detected from STAs associated with the OBSS, a number of other STAs and APs in its environment, a level of traffic in the one or more OBSSs, a number of STAs in the OBSS that support the TWT mode of operation, or a combination of these.

The AP may determine a quantification score by combining the congestion score and the interference score. The AP may adjust a slot duration of the TWT based on the quantification score. If the quantification score is low (e.g., below a first threshold), then the AP may generate a fine grained TWT with a shorter slot duration. In another example, if the quantification score is medium (e.g., between a first and second threshold), then the AP may generate a longer TWT slot. In an alternative example, if the final quantification score is high (e.g., above the second threshold), the AP may disable the TWT mode of operation. For example, the AP may generate one or more TWT slots having duration 0 to disable the TWT mode. In some examples, the AP may identify a TWT slot duration value based at least in part on a table of a plurality of TWT slot duration values corresponding to a plurality of quantification scores. The AP may modify the TWT slot duration based on the table. Thus the quantification score may decide the slot duration for a TWT window in a TWT mode, which may have multiple different durations, including a duration of 0 in some cases.

Aspects of the disclosure are initially described in the context of a wireless communications system. An example of TWT service period (SP) configuration is then described for wireless devices that supports adaptive target wake time scheduling. Examples of TWT configurations are also described for wireless devices that supports adaptive target wake time scheduling. Aspects of the disclosure are further illustrated by and described with reference to apparatus diagrams, system diagrams, and flowcharts that relate to adaptive target wake time scheduling

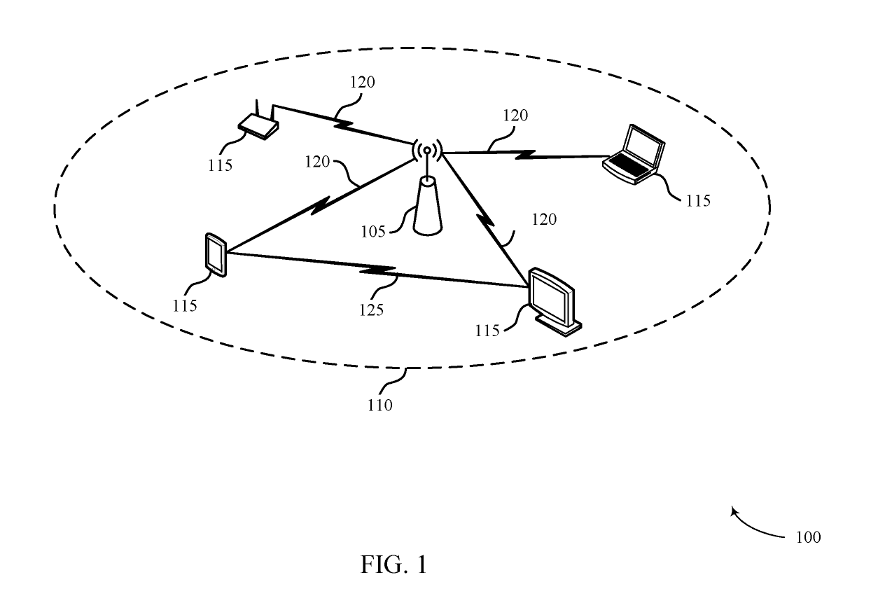

FIG. 1 illustrates a wireless local area network (WLAN) 100 (also known as a Wi-Fi network) configured in accordance with various aspects of the present disclosure. The WLAN 100 may include an AP 105 and multiple associated STAs 115, which may represent devices such as wireless communication terminals, mobile stations, phones, personal digital assistant (PDAs), other handheld devices, netbooks, notebook computers, tablet computers, laptops, display devices (e.g., TVs, computer monitors, etc.), printers, etc. The AP 105 and the associated stations 115 may represent a BSS or an extended service set (ESS). The various STAs 115 in the network are able to communicate with one another through the AP 105. Also shown is a coverage area 110 of the AP 105, which may represent a basic service area (BSA) of the WLAN 100. An extended network station associated with the WLAN 100 may be coupled with a wired or wireless distribution system that may allow multiple APs 105 to be connected in an ESS. WLAN 100 may represent a network that supports adaptive target wake time scheduling.

Although not shown in FIG. 1, a STA 115 may be located in the intersection of more than one coverage area 110 and may associate with more than one AP 105. A single AP 105 and an associated set of STAs 115 may be referred to as a BSS. An ESS is a set of connected BSSs. A distribution system may be used to connect APs 105 in an ESS. In some cases, the coverage area 110 of an AP 105 may be divided into sectors. The WLAN 100 may include APs 105 of different types (e.g., metropolitan area, home network, etc.), with varying and overlapping coverage areas 110. Two STAs 115 may additionally or alternatively communicate directly via a direct wireless link 125 regardless of whether both STAs 115 are in the same coverage area 110. Two STAs 115 may additionally or alternatively communicate directly via a direct wireless link 125 regardless of whether both STAs 115 are in the same coverage area 110. In some cases, a second BSS may be present within a relatively close proximity of coverage area 110. The second BSS may be referred to as an overlapping basic service set. In some cases, the overlapping basic service set may be a source of interference to one or more STAs 115, where additional wireless devices associated with the overlapping basic service set may be referred to as hidden nodes and affect communications and throughput for the STAs 115.

Examples of direct wireless links 120 may include Wi-Fi Direct connections, Wi-Fi Tunneled Direct Link Setup (TDLS) links, and other group connections. STAs 115 and APs 105 may communicate according to the WLAN radio and baseband protocol for physical and MAC layers from IEEE 802.11 and versions including, but not limited to, 802.11b, 802.11g, 802.11a, 802.11n, 802.11ac, 802.11ad, 802.11ah, 802.11ax, etc. In other implementations, peer-to-peer connections or ad hoc networks may be implemented within WLAN 100.

In some cases, a STA 115 (or an AP 105) may be detectable by a central AP 105, but not by other STAs 115 in the coverage area 110 of the central AP 105. For example, one STA 115 may be at one end of the coverage area 110 of the central AP 105 while another STA 115 may be at the other end. Thus, both STAs 115 may communicate with the AP 105, but may not receive the transmissions of the other. This may result in colliding transmissions for the two STAs 115 in a contention based environment (e.g., carrier sense multiple access with collision avoidance (CSMA/CA)) because the STAs 115 may not refrain from transmitting on top of each other. A STA 115 whose transmissions are not identifiable, but that is within the same coverage area 110 may be known as a hidden node. CSMA/CA may be supplemented by the exchange of a request to send (RTS) packet transmitted by a sending STA 115 (or AP 105) and a clear to send (CTS) packet transmitted by the receiving STA 115 (or AP 105). This may alert other devices within range of the sender and receiver not to transmit for the duration of the primary transmission. Thus, RTS/CTS may help mitigate a hidden node problem.

In some cases, an STA 115 or AP 105 may operate in a shared or unlicensed frequency spectrum. Devices in WLAN 100 may communicate over unlicensed spectrum, which may be a portion of spectrum that includes frequency bands traditionally used by Wi-Fi technology, such as the 5 GHz band, the 2.4 GHz band, the 60 GHz band, the 3.6 GHz band, and/or the 900 MHz band. The unlicensed spectrum may additionally or alternatively include other frequency bands. This frequency spectrum may result in the STA 115 or AP 105 contending for access to the wireless medium. Thus, these devices may perform a clear channel assessment (CCA) prior to communicating in order to determine whether the channel is available. A CCA may include an energy detection procedure to determine whether there are any other active transmissions. For example, the device may infer that a change in a received signal strength indicator (RSSI) of a power meter indicates that a channel is occupied. Specifically, signal power is that is concentrated in a certain bandwidth and exceeds a predetermined noise floor may indicate another wireless transmitter. A CCA may also include detection of specific sequences that indicate use of the channel. For example, another device may transmit a specific preamble prior to transmitting a data sequence.

An AP 105 may schedule communication and sleep periods for the STAs 115 that it serves using TWT procedures. The TWT procedures may enable increased power savings by enabling the AP 105 to indicate to specific STAs 115 within a BSS whether they should power up to communicate during a TWT SP. The TWT procedures may be used in two different ways: solicited TWT or broadcast TWT. In some examples, the AP 105 may communicate with a plurality of STAs 115 in a BSS according to a TWT slot duration. The AP 105 may assess its environment to identify one or more congestion factors for the BSS and one or more interference factors for the BSS. The AP 105 may determine a congestion score based at least in part on the congestion factors. In some examples, the AP 105 may determine an interference score based at least in part on the one or more interference factors. In some cases, the AP 105 may determine a quantification score using the congestion score and the interference score. The AP 105 may additionally or alternatively modify the TWT slot duration based at least in part on the quantification score. In some examples, the AP 105 may communicate with the STAs 115 using the modified TWT slot duration. In some examples, prior to communicating with the STAs, the AP may transmit the modified TWT slot duration information to one or more STAs 115.

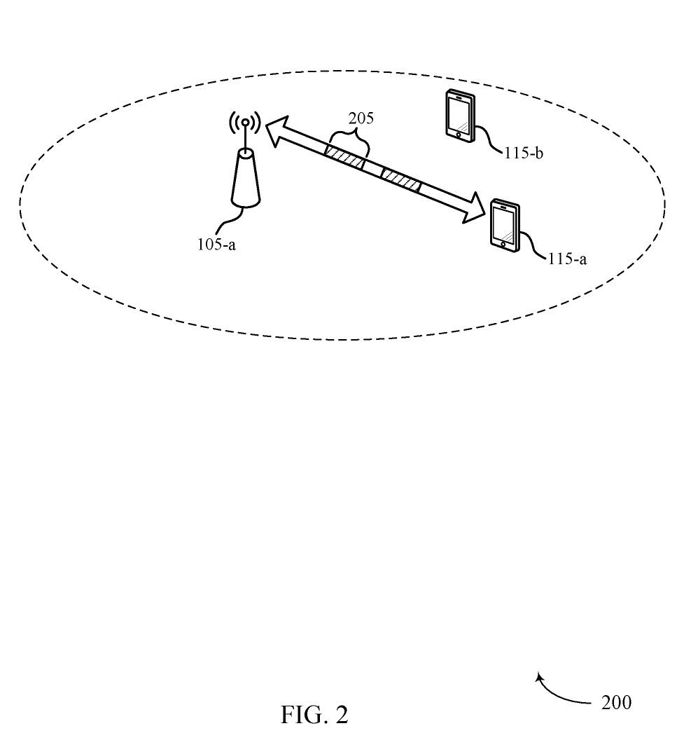

FIG. 2 illustrates an example of a wireless communications system 200 for adaptive target wake time scheduling allocation in accordance with various aspects of the present disclosure. Wireless communications system 200 may include AP 105-a and STA 115-a, which may be examples of the corresponding devices described with reference to FIG. 1. Wireless communications system 200 may represent a system that supports enhanced power saving techniques using adaptive TWT slots for subsets of STAs 115.

In wireless communications system 200, AP 105-a may use TWT procedures to schedule communications for multiple STAs in a BSS. AP 105-a may use a broadcast TWT to dynamically schedule one or more STAs 115 (e.g., STA 115-a and STA 115-b) for efficient communication and power savings. That is, TWT procedures may enable AP 105-a to indicate to specific STAs 115 in a BSS whether they should power up to communicate during a TWT SP 205. The TWT procedures may enable increased power savings and efficiency by enabling scheduled periods of sleep and communication. That is, a TWT procedure may enable AP 105-a to indicate to specific STAs 115 whether they should power up to communicate during an “on” duration (e.g., a TWT slot duration).

In some examples, AP 105-a may broadcast a beacon followed by a trigger frame. In some examples, the transmission time of the trigger frame is signaled in a preceding beacon frame and one or more trigger frames may be scheduled during a given beacon period. In some examples, a beacon frame may be followed by an indication of multicast/broadcast operation. AP 105-a may use a combination of broadcast, multicast, or unicast TWT procedures to communicate with multiple STAs 115 within a BSS. For example, after broadcasting the beacon frame to STAs 115 of the BSS, AP 105-a may transmit signals (e.g., multicast signals) that indicate TWT SPs for the STAs 115 of the BSS.

STA 115-a may be in a power save mode and may be indicated by the beacon frame. In some examples, STA 115-a may send a response acknowledging the received trigger frame. In one example, STA 115-a may not respond to AP 105-a. Following the broadcast of the beacon followed by the multicast/broadcast signals, AP 105-a may assess a number of factors associated with its environment to determine a congestion score (e.g., representing a quantified congestion level), for example related to an amount of traffic within the BSS. In some examples, a TWT slot duration used for a TWT mode of operation may be modified based on the congestion score for STAs 115 of the BSS.

AP 105-a may identify one or more factors related to traffic of the BSS. For example, one or more factors for traffic of the BSS may comprise a first number of the plurality of STAs of the BSS, a second number of the plurality of STAs of the BSS supporting a TWT mode of operation, or a comparison between the first number and the second number. Additionally or alternatively, AP 105-a may determine a ratio between the total number of STAs of the BSS and a number of STAs supporting the TWT mode of operation. In some examples, AP 105-a may determine whether the ratio satisfies a predefined threshold.

In some examples, AP 105-a may identify a depth of transmit queue of the AP (e.g., an amount of data in the transmit buffer). In some examples, the transmit queue is the transmit queue for stations of the BSS. In some examples, AP 105-a may determine whether the amount of data in the transmit buffer satisfies a predetermined threshold. In some examples, AP 105-a may identify a number of transmit queue of the AP.

Additionally or alternatively, AP 105-a may assign weights to a number of factors for STAs 115 of the BSS used to determine the congestion score. In some examples, the congestion score may be an aggregate of the weighted factors. AP 105-a may gauge its environment before creating a TWT window for STAs 115 of the BSS. Additionally or alternatively, AP 105-a may periodically gauge its environment to quantify the congestion level, after the TWT window is created. In some examples, AP 105-a may update the congestion score based on a congestion history of its environment. In some examples, the congestion history can be historical congestion scores associated with the traffic of the BSS. In some examples, the congestion history may be associated with historical values for different congestion factors for the BSS. In some examples, the congestion history may be a congestion pattern of the environment of the AP 105-a.

In some examples, in addition to the congestion score, AP 105-a may assess its environment to quantify an interference score (e.g., representing a quantification of the interference level experienced in the BSS). In some examples, AP 105-a may identify one or more factors related to traffic outside the BSS, for example for one or more OBSSs. The interference level may indicate a number of STAs within one or more OBSSs that support a reduced TWT mode of operation, or does not support the TWT mode of operation. In some examples, the one or more factors for traffic of one or more OBSSs may comprise of energy detected from the OBSS. For example, energy detected from the OBSS may be detected from a number of STAs in the OBSS. In some examples, an interference factor may be a number of detected STAs of the OBSS. In some examples, an interference number may be a number of detected APs of the OBSS. In some examples, the AP 105-a may determine a traffic level for the OBSS. For example, the AP 105-a may determine a total number of STAs in the OBSS. In some examples, the AP 105-a may determine a number of STAs of the OBSS that support a TWT mode of operation. In some examples, the interference factors may be combined according to one or more weights to generate a composite interference factor.

In some examples, AP 105-a may determine an interference score. Additionally or alternatively, AP 105-a may assign weights to a number of factors for STAs 115 outside the BSS, for example of one or more OBSSs. In some examples, the interference score may be an aggregate of the weighted factors. For example, AP 105-a may assign a weight to each of the factors for determining the interference score. In some examples, a number of STAs of the OBSS that support TWT mode of operation may have a higher weight than the energy detected from outside the BSS (e.g., based on a measurement of received signal strength, such as RSSI). In some examples, AP 105-a may determine a ratio between a number of STAs of the OBSS that support TWT mode of operation and a total number of STAs of the OBSS. Additionally or alternatively, AP 105-a may determine the interference score based at least in part on the ratio.

After the generation of the interference score, AP 105-a may determine a quantification score (e.g., a quantification metric) based at least in part on the congestion score and the interference score. In some examples, AP 105-a may generate the quantification score by combining the congestion score and the interference score. In some examples, AP 105-a may assign a first weight to the congestion score and a second weight to the interference score. In such cases, AP 105-a may determine the quantification score based at least in part on the weighted congestion score and the weighted interference score.

Then, AP 105-a may modify TWT slot duration based at least in part on the determined quantification score. In some examples the TWT slot duration may be quantized, such that the duration may be selected to be one of three different durations. In other examples, the TWT slot duration may be one of a greater number of different durations, or one of a few number of durations, including a zero duration where no TWT slots exist in a certain TWT SP. In some examples, AP 105-a may determine whether the quantification score is below a first threshold. If AP 105-a determines that the quantification score is low (e.g., below the first threshold), then AP 105-a may generate a fine grained TWT with a shorter slot duration. In some examples, AP 105-a may determine whether the quantification score is between a first threshold and a second threshold. In such cases, if AP 105-a determines that the final quantification score is medium (e.g., between a first and second threshold), then AP 105-a may generate a longer TWT slot (e.g., longer than the fine grained TWT). In some examples, AP 105-a may determine whether the quantification score is greater than the second threshold. If the final quantification score is high (e.g., above the second threshold), AP 105-a may set the TWT slot duration to zero or disable the TWT mode of operation.

In some examples, AP 105-a may identify a TWT slot duration value based at least in part on a table of a plurality of TWT slot duration values corresponding to a plurality of quantification scores and may update the TWT slot duration to use to communicate with the plurality of STAs using the identified TWT slot duration value. For example, AP 105-a may generate one or more TWT slots having duration 0 to disable the TWT mode. Thus the quantification score may decide the slot duration for a TWT window in a TWT mode, which may have multiple different durations, or have a duration of 0.

In some cases, AP 105-a may communicate with the STAs (e.g., STA 115-a and 115-b) in the BSS according to the modified TWT slot duration. In some cases, before communicating, AP 105-a may transmit an indication of the modified TWT slot duration to the plurality of STAs of the BSS. In some examples, AP 105-a may transmit the indication of the modified TWT slot duration in a management transmission, such as a beacon frame, during a TWT SP. In some cases, AP 105-a may transmit data to a first set of the plurality of STAs in the BSS during a downlink portion of a TWT slot having the modified TWT slot duration and may receive data from the first set of the plurality of STAs in the BSS during an uplink portion of the TWT slot.

In some examples, after communicating with the modified TWT duration for a predetermined period of time, AP 105-a may again gauge its environment (e.g., STAs in BSS and STAs in OBSS) to update the congestion score and the interference score. In such cases, AP 105-a may generate an updated quantification score based on the updated congestion score and the updated interference score, and determine, if applicable, a new TWT slot duration or continue to use the existing TWT slot duration.

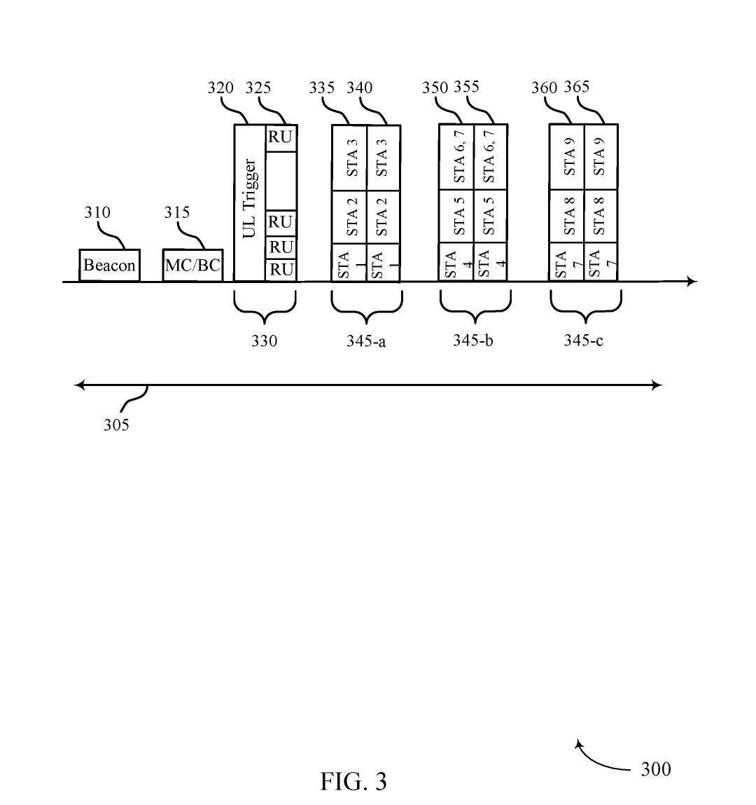

FIG. 3 illustrates an example of a TWT SP configuration 300 for adaptive target wake time scheduling allocation in accordance with various aspects of the present disclosure. In some cases, TWT SP configuration 300 may represent aspects of techniques performed by an AP 105 or an STA 115 as described with reference to FIGS. 1-2. TWT SP configuration 300 may illustrate an example of multiple TWT slots within a TWT SP, where the TWT SP may serve a subset of STAs 115.

As an example, a beacon 310 may announce that a beacon period may include a TWT SP 305, where each TWT SP 305 may service a different subset of STAs 115. For example, a TWT SP 305 may service STA 1 through STA 9. In some cases, the beacon 310 may indicate the presence of additional information that follows the beacon 310. The additional information may include the presence and timing of TWT SP 305. For example, the beacon 310 may indicate the timing of STAs 115 (e.g., STA 1 through STA 9) in TWT SP 305. Prior to the beginning of TWT SP 305, an AP 105 may transmit a beacon 310 that indicates the transmission time of a trigger frame 315 within the TWT SP 305.

In some cases, one or more trigger frames 315 may be scheduled during a given beacon period. In some examples, trigger frame 315 may include multicast/broadcast information. In some examples, a TWT IE within either a beacon 310 or trigger frame 315 may be used to indicate that the STAs 115 signaled in the trigger frame will be served in TWT SP 305. Additionally or alternatively, the TWT IE may indicate whether TWT SP 305 is intended to serve only UL, only DL, or both UL and DL communications with the indicated STAs 115. In some cases, either the beacon 310 or the trigger frame 315 may include a traffic indication map (TIM) bit set for a subset of STAs 115.

In some cases, a broadcast TWT slot 330 may include an uplink trigger 320 in the DL portion of the slot. In some examples, the broadcast TWT slot 330 may include one or more resource units for one or more STAs. Additionally or alternatively, the one or more resource units (RUs) may be included in an uplink portion of the slot. In some cases, broadcast TWT slot 330 may include a mapping of resource units to STAs.

Following transmission of the broadcast TWT slot 330 to the one or more STAs 115, the AP 105 may transmit DL transmission 335 during TWT slot 345-a in TWT SP 305, where DL transmission 335 may include transmissions for STA 1, STA 2, and STA 3. In response to the DL transmission 335 received from the AP 105, STAs 115 may transmit UL transmission 340 during TWT slot 345-a in TWT SP 305. In some cases, the UL transmission 340 may include a multi-TID block acknowledgment (M-BA).

Following transmission of the TWT slot 345-a to the one or more STAs 115, the AP 105 may continue with sending DL transmission 350 during TWT slot 345-b in TWT SP 305, where DL transmission 350 may include a resources for STA 4, STA 5, STA 6 and STA 7. In response to the DL transmission 350 received from the AP 105, STAs 115 may transmit UL transmission 355 during TWT slot 345-b in TWT SP 305. In some cases, the UL transmission 355 may include an M-BA.

In some examples, after DL transmission 350 (which may be sent using OFDMA/MU communication), the short interframe space (SIFS) bursts may continue to allow for UL RU allocation for UL transmissions. For example, the AP 105 may send DL transmission 350. The STA 115 may then send UL data and M-BA frames as UL transmission 355 to the AP 105. In some examples, DL transmission 350 may include a DL data, or a trigger, or both.

In some examples, following transmission of the TWT slot 345-b to the one or more STAs 115, the AP 105 may continue with sending DL transmission 360 during TWT slot 345-c in TWT SP 305, where DL transmission 360 may include a resources for STA 7, STA 8 and STA 9. In response to the DL transmission 360 received from the AP 105, STAs 115 may transmit UL transmission 365 during TWT slot 345-c in TWT SP 305. In some cases, the UL transmission 365 may include an M-BA.

In some cases, a power management (PM) bit for the one or more STAs 115 may be set to either one or zero, and the STAs 115 may be awake based at least in part on the state of the PM bit.

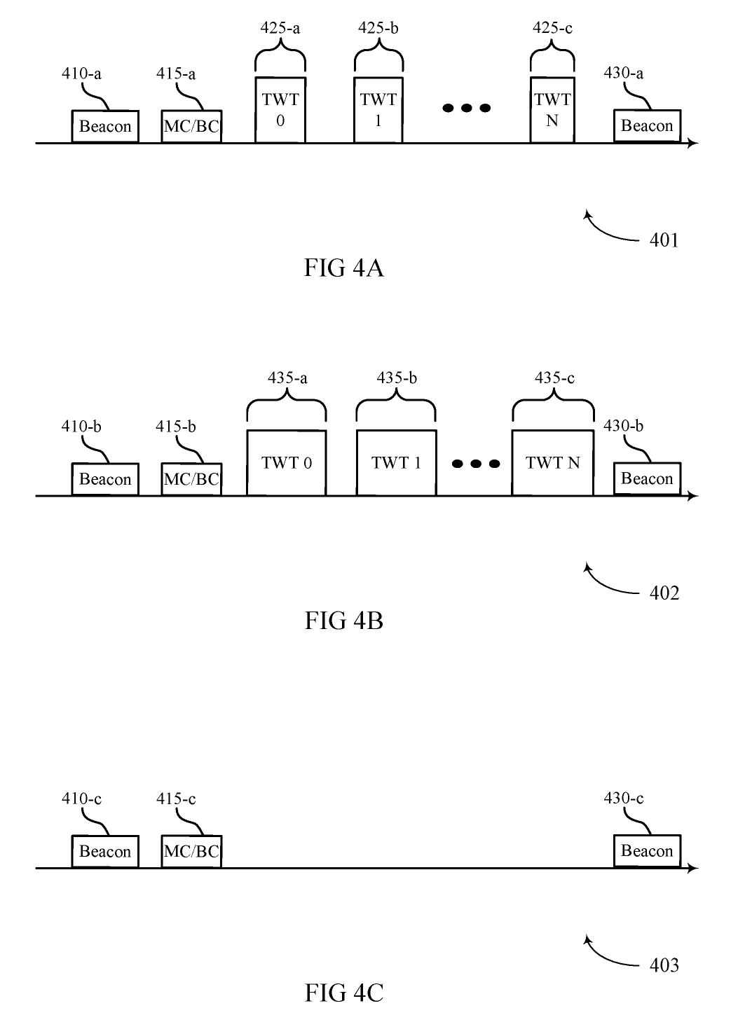

FIGS. 4A-4C illustrate examples of TWT configurations for adaptive target wake time scheduling allocation in accordance with various aspects of the present disclosure.

In some examples, AP 105 may identify one or more interference or congestion factors for a BSS, or interference or congestion factors outside the BSS (e.g., for one or more OBSSs), or both. In some cases, the one or more congestion factors for the BSS may include a number of STAs of the BSS, a number of STAs of the BSS supporting a TWT mode of operation, or a comparison between the number of STAs of the BSS and the number of STAs of the BSS supporting the TWT mode of operation. In other examples, a congestion factor may be a depth of the transmit queue of the AP, or a number of transmit queue of the AP, or both.

In some examples, AP 105 may determine a congestion score based at least in part on one or more of the described congestion factors for the BSS. In some cases, AP 105 may assign one or more weights to the congestion factors used to determine the congestion score. For example, AP 105 may determine a first number of STAs 115 of the BSS, that support a TWT mode of operation and a total number of STAs 115 of the BSS. Additionally or alternatively, AP 105 may determine a ratio between the first number of STAs 115 of the BSS and the total number of STAs 115 of the BSS. Additionally or alternatively, AP 105 may identify the congestion score based at least in part on the identified ratio. In some examples, the congestion score may be obtained by assigning weights to congestion factors like depth of the transmit queue and number of transmit queue. The congestion score may be defined as a metric that describes an amount of BSS traffic that can justify the need for a TWT mode of operation.

In some cases, the one or more interference factors for outside the BSS, including the one or more OBSSs may include an energy detected from outside the BSS (e.g., for one or more neighboring OBSSs), for example an interference measurement (e.g., as indicated by a received signal strength indicator (RSSI)). Other interference factors may include a number of detected STAs or detected APs for neighboring OBSSs. In some cases one of the interference factors may be a traffic level for the OBSS, for example as measured at the AP of the BSS, or as communicated to the AP 105 by a STA of the BSS, or APs or STAs of one or more of the OBSSs. In still other examples, an interference factor may include a number of STAs outside the BSS, for example in one or more of the OBSSs, that support a TWT mode of operation. AP 105 may also compare a total number of neighboring STAs 115 to a number of the STAs 115 supporting TWT modes of operation to obtain an interference factor.

In some examples, AP 105 may determine an interference score. Additionally or alternatively, AP 105 may identify the interference score based at least in part on the one or more interference factors for traffic outside the BSS, including in one or more neighboring OBSSs. In some examples, AP 105 may identify the interference score based at least in part on a total energy detected on one or more subcarriers, including one or more frequency ranges, from outside the BSS. An interference factor may also include a number of detected APs of neighboring OBSSs, or a traffic level for the neighboring OBSSs, or some combination of these interference factors. In some cases, AP 105 may assign a weighting factor to the interference factors to determine the interference score. For example, AP 105 may determine a first number STAs of a neighboring OBSS that supports a TWT mode of operation and a total number of detected STAs of the OBSS. AP 105 may determine a ratio between the first number STAs for the neighboring OBSS and the total number of detected STAs of the OBSS. In some examples, AP 105 may determine the interference score based at least in part on the determined ratio. Additionally or alternatively, AP 105 may assign a weight to each factor used for calculating the interference score. In some examples, the interference score may be defined as a metric that indicates an amount of traffic outside the BSS, for example in one or more neighboring OBSSs, that can justify the need for a non-TWT or reduced TWT mode of operation.

In some examples, AP 105 may determine a quantification score (e.g., a quantification metric). AP 105 may determine the quantification score based at least in part on the congestion score. In some examples, AP 105 may determine the quantification score based at least in part on the interference score. AP 105 may also determine the quantification score based on a combination of the congestion score and the interference score. In some cases, AP 105 may determine the quantification score based at least in part on a weighted congestion score and a weighted interference score. For example, AP 105-b may apply a first weight to the congestion score and the second weight to the interference score. In some examples, AP 105 may determine the quantification score based at least in part on the weights assigned to each factor used in calculating the congestion score and the interference score. In some examples, AP 105 may periodically obtain updated congestion and interference factors, including for the BSS and the OBSS. In some case, AP 105 may periodically update the quantification score based on the updated congestion and interference factors.

In some examples, AP 105 may modify the TWT slot duration to be one of a set number of durations based at least in part on comparing the determined quantification score to one or more thresholds. In some examples, AP 105 may determine whether the quantification score is below a first threshold. If the quantification score is low (e.g., below the first threshold), then the AP 105 may generate a fine grained TWT, with a shorter slot duration. Such TWT slot duration may have a set predefined value. In some examples, AP 105 may determine whether the quantification score is between a first threshold and a second threshold. In such cases, if the final quantification score is medium (e.g., between a first and second threshold), then AP 105 may generate a longer TWT slot (e.g., having a set predefined value longer than the fine grained TWT). In some examples, AP 105 may determine whether the quantification score is greater than the second threshold. If the final quantification score is high (e.g., above the second threshold), AP 105 may disable the TWT mode of operation. For example, AP 105 may generate one or more TWT slots having duration 0, or tear down TWT or pause TWT, to disable the TWT mode. In some examples, AP 105 may identify a TWT slot duration value based at least in part on a table of a plurality of TWT slot duration values corresponding to a plurality of quantification scores and may update the TWT slot duration to use to communicate with the plurality of STAs using the identified TWT slot duration value.

Using the above referenced parameters, Table 1 provides examples of TWT slot durations associated with various combinations of congestion scores and interference scores.

TABLE 1

| Congestion | Interference | Quantification | |
|---|---|---|---|
| Score | Score | Score | TWT |
| High | Low | Low | Fine |
| High | Medium | Medium | Course |
| High | High | High | No TWT |
| Low | Any | High | No TWT |

In some examples, AP 105 may identify a TWT slot duration value based at least in part on the table (e.g., Table 1) of a plurality of TWT slot duration values corresponding to a plurality of quantification scores. AP 105 may update the TWT slot duration to use to communicate with the plurality of stations using the identified TWT slot duration value. Based on results represented in Table 1, a TWT slot duration may be modified based on the interference and/or congestion factors for the BSS.

FIG. 4A illustrates example of TWT configuration 401 for adaptive target wake time scheduling allocation in accordance with various aspects of the present disclosure. In some cases, TWT configuration 401 may represent aspects of techniques performed by an AP 105 or an STA 115 as described with reference to FIGS. 1-3. TWT configuration 401 may illustrate an example of multiple TWT slots within a TWT SP, where the TWT SP may serve one or more STAs 115.

A beacon 410-a may announce a TWT SP period, where each TWT SP may service a subset of STAs 115. In some examples, a TWT SP may service a subset of STAs 115 of a BSS. In some cases, the beacon 410-a may indicate the presence of additional information that follows the beacon 410-a. The additional information may include the presence and timing of the TWT SP. In some cases, the additional information may include the TWT slot duration used during the TWT SP. Prior to the beginning of TWT SP, an AP 105 may transmit a beacon 410-a that indicates the transmission time of a trigger frame 415-a.

In some cases, one or more trigger frames 415-a may be transmitted during a given beacon period. In some examples, trigger frame 415-a may include multicast/broadcast information. In some examples, a TWT IE within either a beacon 410-a or trigger frame 415-a may be used to indicate that the STAs 115 signaled in the trigger frame may transmit and receive in a TWT SP. In some examples, the TWT IE within the beacon 410-a or trigger frame 415-a may be used to indicate the TWT slot duration. Additionally or alternatively, the TWT IE may indicate whether TWT SP is intended to serve UL, or DL, or both UL and DL communications with the indicated STAs 115. In some cases, the beacon 410-a or the trigger frame 415-a may include a traffic indication map (TIM) bit set for a subset of STAs 115.

In the example of TWT configuration 401 the TWT slot durations for TWT 0 425-a, TWT 1 425-b through TWT n 425-c are fine grained. In this example, AP 105 may have a modified TWT slot duration based at least in part on a determined quantification score, determined as further described above with reference to FIGS. 1-3. AP 105 may determine whether the quantification score is below a first threshold. If the quantification score is below the first threshold, then AP 105 may generate the fine grained TWT slot (e.g., TWT 0 425-a, TWT 1 425-b and TWT n 425-c) with a shorter slot duration. In some examples, AP 105 may identify the TWT sot duration from a table (e.g., Table 1). In such cases, if the determined congestion score is high and the determined interference score is low, then AP 105 may modify the TWT slot duration to be fine grained. In some examples, beacon 430-a may announce beginning of a next beacon period may include a next TWT SP.

In some examples, AP 105 may observe a high throughput bidirectional user datagram protocol (UDP) traffic from a first STA 115 to a second STA 115, and a high throughput downlink bidirectional UDP traffic from AP 105 to the first STA 115 and the second STA 115. In such case, a high congestion score and a low interference score may be observed, leading to a quantification score determine to be high, such that the TWT slot duration may be modified (or maintained to be) a fine grained TWT slot duration.

FIG. 4B illustrates example of TWT configuration 402 for adaptive target wake time scheduling allocation in accordance with various aspects of the present disclosure. In some cases, TWT configuration 402 may represent aspects of techniques performed by an AP 105 or an STA 115 as described with reference to FIGS. 1-3. TWT configuration 402 may illustrate an example of multiple TWT slots within a TWT SP, where the TWT SP may serve one or more STAs 115.

A beacon 410-b may announce a beacon period may include a TWT SP, where each TWT SP may service a subset of STAs 115. In some examples, a TWT SP may service a subset of STAs 115 of a BSS. In some cases, the beacon 410-b may indicate the presence of additional information that follows the beacon 410-b. The additional information may include the presence and timing of the TWT SP. In some cases, the additional information may include the TWT slot duration used during the TWT SP. Prior to the beginning of TWT SP, an AP 105 may transmit a beacon 410-b that indicates the transmission time of a trigger frame 415-b.

In some cases, one or more trigger frames 415-b may be transmitted during a given beacon period. In some examples, trigger frame 415-b may include multicast/broadcast information. In some examples, a TWT IE within either a beacon 410-b or trigger frame 415-b may be used to indicate that the STAs 115 signaled in the trigger frame may transmit and receive in a TWT SP. In some examples, the TWT IE within the beacon 410-b or trigger frame 415-b may be used to indicate the TWT slot duration. Additionally or alternatively, the TWT IE may indicate whether TWT SP is intended to serve UL, or DL, or both UL and DL communications with the indicated STAs 115. In some cases, the beacon 410-b or the trigger frame 415-b may include a TIM bit set for a subset of STAs 115.

In the example of TWT configuration 401 the TWT slot durations for TWT 0 435-a, TWT 1 435-b through TWT n 435-c are course (e.g., the TWT slots have longer duration). In this example, AP 105 may have a modified TWT slot duration based at least in part on a determined quantification score, determined as further described above with reference to FIGS. 1-3. AP 105 may determine whether the quantification score is between a first threshold and a second threshold. In such cases, if the final quantification score is medium (e.g., between a first and second threshold), then AP 105 may generate a longer TWT slot (e.g., TWT 0 435-a, TWT 1 435-b and TWT n 435-c). In some examples, AP 105 may identify the TWT sot duration from a table (e.g., Table 1). In such cases, if the determined congestion score is high and the determined interference score is medium, then AP 105 may modify the TWT slot duration to be course (e.g., longer duration). In some examples, beacon 430-b may announce beginning of a next beacon period may include a next TWT SP.

In some examples, AP 105 may observe high throughput bidirectional UDP traffic from a first STA 115 to a second STA 115, a high throughput downlink bidirectional UDP traffic from an AP 105 to the first STA 115 and the second STA 115, and a medium load traffic between a second AP 105 in an OBSS and one or more STAs 115 of the OBSS. In such case, a high congestion score and a medium interference score may be observed, leading to a quantification score determine to be medium, such that the TWT slot duration may be modified (or maintained to be) a coarse TWT slot duration.

FIG. 4C illustrates example of TWT configuration 403 for adaptive target wake time scheduling allocation in accordance with various aspects of the present disclosure. In some cases, TWT configuration 403 may represent aspects of techniques performed by an AP 105 or an STA 115 as described with reference to FIGS. 1-3. TWT configuration 403 may illustrate an example of multiple TWT slots within a TWT SP, where the TWT SP may serve one or more STAs 115.

A beacon 410-c may announce a beacon period may include a TWT SP, where each TWT SP may service a subset of STAs 115. In some examples, a TWT SP may service a subset of STAs 115 of a BSS. In some cases, the beacon 410-c may indicate the presence of additional information that follows the beacon 410-c. The additional information may include the presence and timing of the TWT SP. In some cases, the additional information may include the TWT slot duration used during the TWT SP. Prior to the beginning of TWT SP, an AP 105 may transmit a beacon 410-c that indicates the transmission time of a trigger frame 415-c.

In some cases, one or more trigger frames 415-c may be transmitted during a given beacon period. In some examples, trigger frame 415-c may include multicast/broadcast information. In some examples, a TWT IE within either a beacon 410-c or trigger frame 415-c may be used to indicate that the STAs 115 signaled in the trigger frame may transmit and receive in a TWT SP. In some examples, the TWT IE within the beacon 410-c or trigger frame 415-c may be used to indicate the TWT slot duration (or indication of TWT slot duration of 0).

In this example, the TWT slots are disabled by AP 105. In such examples, AP 105 may disable TWT slots based at least in part on a determined quantification score, determined as further described above with reference to FIGS. 1-3. AP 105 may determine whether the quantification score is greater than the second threshold. If the quantification score is high (e.g., above the second threshold), AP 105 may disable the TWT mode of operation. For example, AP 105 may generate one or more TWT slots having duration 0 to disable the TWT mode. In some examples, AP 105 may identify a TWT slot duration value (0, in this case) based at least in part on a table of a plurality of TWT slot duration values (e.g., Table 1). In such cases, if the determined congestion score is high and the determined interference score is high, then AP 105 may disable the TWT slot duration (e.g., duration 0). In some examples, if the determined congestion score is high and the determined interference score is indeterminable, then AP 105 may disable the TWT slot duration. In some examples, beacon 430-c may announce beginning of a next beacon period may include a next TWT SP.

In some examples, AP 105 may observe high throughput bidirectional UDP traffic from a first STA 115 to a second STA 115, a high throughput downlink bidirectional UDP traffic from a first AP 105 of the BSS to the first STA 115 and the second STA 115, a medium load traffic between a second AP 105 of a neighboring BSS (e.g., an OBSS) and one or more STAs 115 of the OBSS, and a high DL traffic between AP 105 and one or more STAs 115 operating according to a different 802.11 protocol in the OBSS than the 802.11 protocol used AP 105 to communication with STAs 115 in the BSS, TWT slot duration may be disabled.

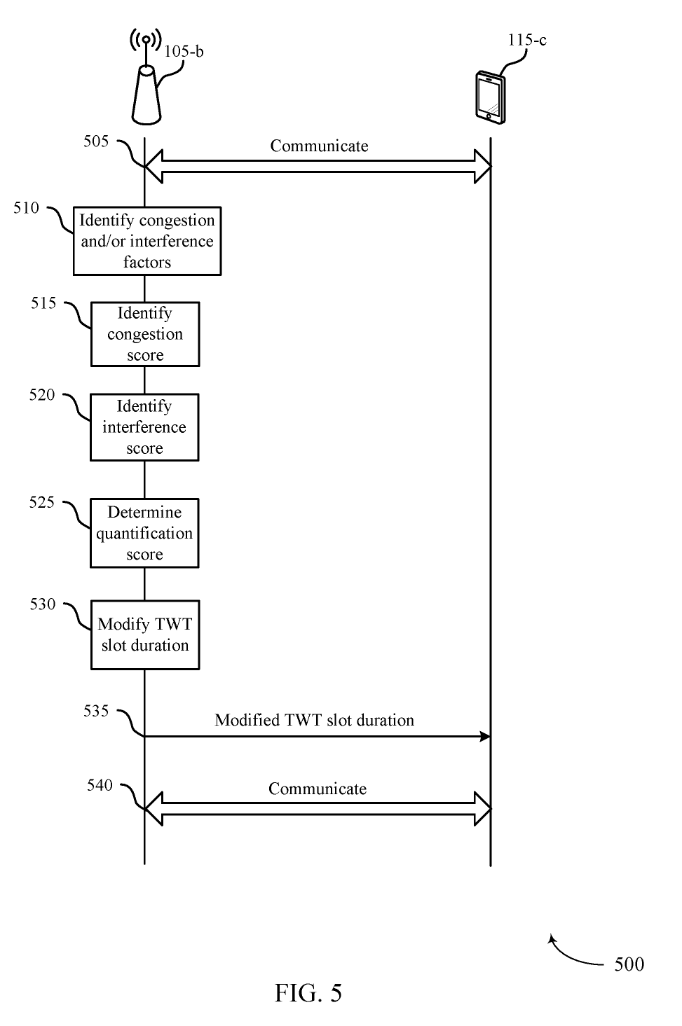

FIG. 5 illustrates an example of a process flow 500 for a system that supports adaptive target wake time scheduling allocation in accordance with various aspects of the present disclosure. Process flow 500 may include AP 105-b and STA 115-c which may be examples of the corresponding devices described with reference to FIG. 1-4.

At step 505, AP 105-b may communicate with STA 115-c according to a TWT slot duration. In some examples, AP 105-b may broadcast, and STA 115-c may receive, a beacon that identifies a timing for a TWT SP for a BSS. In some examples, AP-105-b may communicate with one or more STAs 115-c in a BSS. In some cases, a beacon period initiated by the beacon includes the TWT SP. Additionally or alternatively, a beacon period initiated by the beacon may include the TWT SP.

At step 510, AP 105-b may identify one or more congestion or interference factors for traffic of the BSS, or traffic outside the BSS (e.g., in one or more OBSSs), or a combination thereof. In some cases, the one or more congestion factors for the BSS include a first number of the multiple STAs of the BSS, a second number of the multiple of STAs of the BSS supporting a TWT mode of operation, or a comparison between the first number and the second number, or a depth of transmit queue of the AP, or a number of transmit queue of the AP, or a combination of these. In some cases, the one or more interference factors for traffic of the OBSS comprise an energy detected for signals external to the BSS (e.g., from one or more OBSSs), which may also include energy detected from the BSS. The one or more interference factors may also include a number of detected STAs of the OBSS, or a number of detected APs of the OBSS, or a traffic level for the OBSS, or a number of STAs of the OBSS that support a TWT mode of operation, or a combination of these.

At step 515, AP 105-b may identify a congestion score. AP 105-b may identify the congestion score based at least in part on the one or more identified congestion factors for the BSS, as described with reference to step 510. In some cases, AP 105-b may assign a weighting factor to the congestion score. For example, AP 105-b may determine a first number of STAs 115-c of the BSS, that support a TWT mode of operation and a total number of STAs 115-c of the BSS. AP 105-b may determine a ratio between the first number of STAs 115-c of the BSS and the total number of STAs 115-c of the BSS. Additionally or alternatively, AP 105-b may identify the congestion score based at least in part on the identified ratio.

At step 520, AP 105-b may identify an interference score. AP 105-b may identify the interference score based at least in part on the one or more interference factors, as described with reference to step 510. In some cases, AP 105-b may assign a weighting factor to the interference score. For example, AP 105-b may determine a first number STAs of the OBSS that support a TWT mode of operation and a total number of detected STAs of the OBSS. AP 105-b may determine a ratio between the first number STAs of the OBSS and the total number of detected STAs of the OBSS. Additionally or alternatively, AP 105-b may identify the interference score based at least in part on the determined ratio.

At step 525, AP 105-b may determine a quantification score. AP 105-b may determine the quantification score based at least in part on the congestion score, the interference score, or both the congestion score and the interference score. In some cases, AP 105-b may determine the quantification score based at least in part on a weighted congestion score and a weighted interference score. For example, AP 105-b may apply a first weight to the congestion score and the second weight to the interference score. AP 105-b may determine the quantification score based at least in part on the first weight applied to the congestion score and the second weight applied to the interference score.

At step 530, AP 105-b may modify TWT slot duration based at least in part on the determined quantification score. In some examples, AP 105-b may determine whether the quantification score is below a first threshold. If the quantification score is low (e.g., below the first threshold), then the AP 105-b may generate a fine grained TWT with a shorter slot duration. In some examples, AP 105-b may determine whether the quantification score is between a first threshold and a second threshold. In such cases, if the final quantification score is medium (e.g., between a first and second threshold), then AP 105-b may generate a longer TWT slot (e.g., longer than the fine grained TWT). In some examples, AP 105-b may determine whether the quantification score is greater than the second threshold. If the final quantification score is high (e.g., above the second threshold), AP 105-b may disable the TWT mode of operation. For example, AP 105-b may generate one or more TWT slots having duration 0 to disable the TWT mode. In some examples, AP 105-b may identify a TWT slot duration value based at least in part on a table of a plurality of TWT slot duration values corresponding to a plurality of quantification scores and may update the TWT slot duration to use to communicate with the plurality of STAs using the identified TWT slot duration value.

At step 535, AP 105-b may transmit an indication of the modified TWT slot duration to the plurality of STAs 115 of the BSS. In some cases, AP 105-b may transmit the indication of the modified TWT slot duration in a management frame (e.g., a beacon) during a TWT SP.

At step 540, AP 105-b may communicate with a plurality of STAs (e.g., STA 115-c) in the BSS according to the modified TWT slot duration. In some cases, AP 105-b may transmit data to a first set of the plurality of STAs in the BSS during a DL portion of a TWT slot having the modified TWT slot duration and may receive data from the first set of the plurality of STAs in the BSS during an UL portion of the TWT slot.

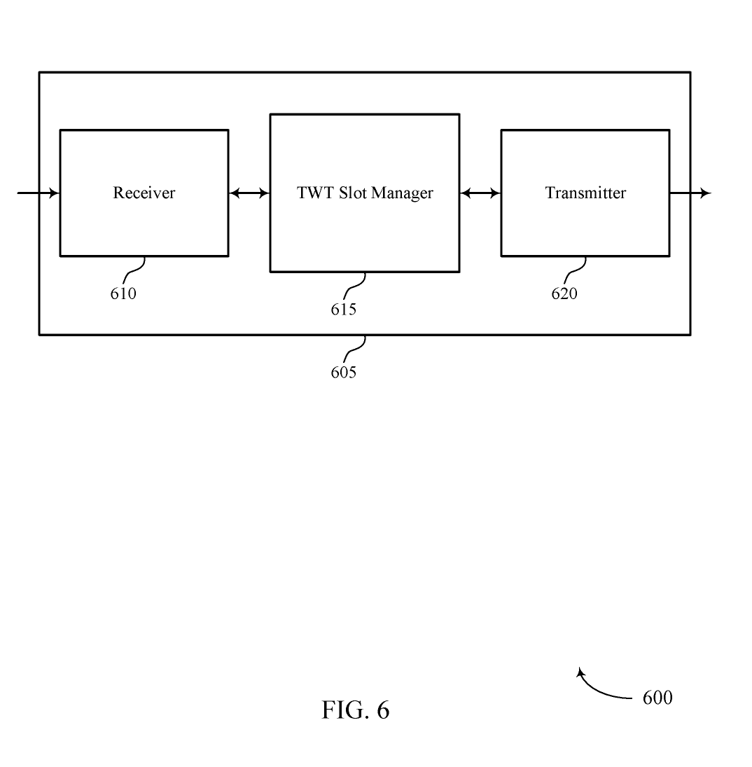

FIG. 6 shows a block diagram 600 of a wireless device 605 that supports adaptive target wake time scheduling in accordance with various aspects of the present disclosure. Wireless device 605 may be an example of aspects of an AP 105 as described with reference to FIG. 1. Wireless device 605 may include receiver 610, TWT slot manager 615, and transmitter 620. Wireless device 605 may also include one or more processors, memory coupled with the one or more processors, and instructions stored in the memory that are executable by the one or more processors to enable the one or more processors to perform the roaming features discussed herein. Each of these components may be in communication with one another (e.g., via one or more buses).

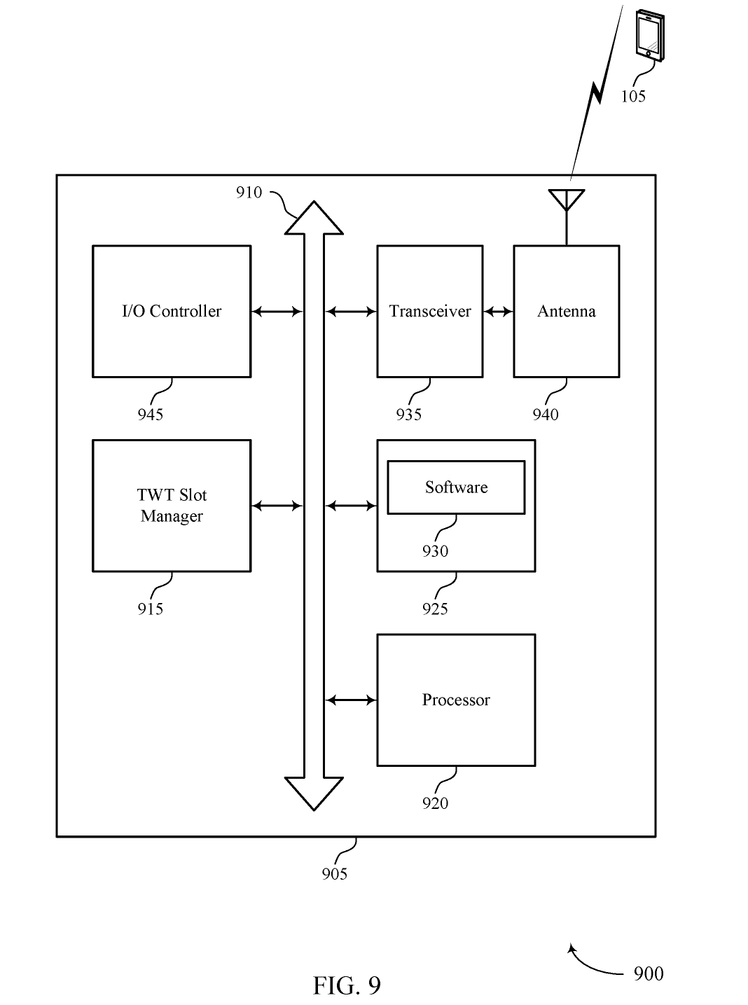

Receiver 610 may receive information such as packets, user data, or control information associated with various information channels (e.g., control channels, data channels, and information related to adaptive target wake time scheduling, etc.). Information may be passed on to other components of the device. The receiver 610 may be an example of aspects of the transceiver 935 described with reference to FIG. 9.

TWT slot manager 615 may be an example of aspects of the TWT slot manager 915 described with reference to FIG. 9.

TWT slot manager 615 and/or at least some of its various sub-components may be implemented in hardware, software executed by a processor, firmware, or any combination thereof. If implemented in software executed by a processor, the functions of the TWT slot manager 615 and/or at least some of its various sub-components may be executed by a general-purpose processor, a digital signal processor (DSP), an application-specific integrated circuit (ASIC), an field-programmable gate array (FPGA) or other programmable logic device, discrete gate or transistor logic, discrete hardware components, or any combination thereof designed to perform the functions described in the present disclosure. The TWT slot manager 615 and/or at least some of its various sub-components may be physically located at various positions, including being distributed such that portions of functions are implemented at different physical locations by one or more physical devices. In some examples, TWT slot manager 615 and/or at least some of its various sub-components may be a separate and distinct component in accordance with various aspects of the present disclosure. In other examples, TWT slot manager 615 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

TWT slot manager 615 may communicate with a set of stations in a BSS according to a TWT slot duration, identify one or more congestion or interference factors for the BSS, modify the TWT slot duration based on the one or more congestion or interference factors, and communicate with the set of stations in the BSS according to the modified TWT slot duration.

Transmitter 620 may transmit signals generated by other components of the device. In some examples, the transmitter 620 may be collocated with a receiver 610 in a transceiver module. For example, the transmitter 620 may be an example of aspects of the transceiver 935 described with reference to FIG. 9. The transmitter 620 may include a single antenna, or it may include a set of antennas.

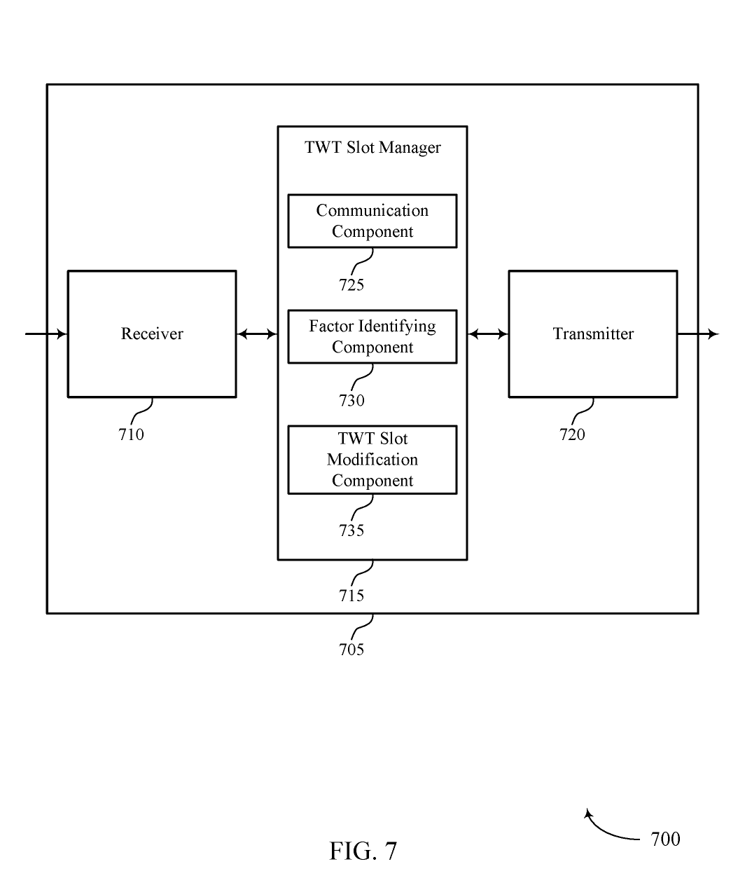

FIG. 7 shows a block diagram 700 of a wireless device 705 that supports adaptive target wake time scheduling in accordance with various aspects of the present disclosure. Wireless device 705 may be an example of aspects of a wireless device 605 or an AP 105 as described with reference to FIGS. 1 and 6. Wireless device 705 may include receiver 710, TWT slot manager 715, and transmitter 720. Wireless device 705 may also include one or more processors, memory coupled with the one or more processors, and instructions stored in the memory that are executable by the one or more processors to enable the one or more processors to perform the roaming features discussed herein. Each of these components may be in communication with one another (e.g., via one or more buses).

Receiver 710 may receive information such as packets, user data, or control information associated with various information channels (e.g., control channels, data channels, and information related to adaptive target wake time scheduling, etc.). Information may be passed on to other components of the device. The receiver 710 may be an example of aspects of the transceiver 935 described with reference to FIG. 9.

TWT slot manager 715 may be an example of aspects of the TWT slot manager 915 described with reference to FIG. 9. TWT slot manager 715 may also include communication component 725, factor identifying component 730, and TWT slot modification component 735.

Communication component 725 may communicate with a set of stations in a BSS according to a TWT slot duration, communicate with the set of stations in the BSS according to the modified TWT slot duration, communicate with a second set of the set of stations in the BSS during the TWT SP and outside the one or more TWT slots, and receive data from the first set of the set of stations in the BSS during an uplink portion of the TWT slot. In some cases, communicating with the set of stations in the BSS according to the modified TWT slot duration includes: communicating with a first set of the set of stations in the BSS during one or more TWT slots of a TWT SP, the one or more TWT slots having the modified TWT slot duration. In some cases, communicating with the set of stations in the BSS according to the modified TWT slot duration includes: transmitting data to a first set of the set of stations in the BSS during a downlink portion of a TWT slot having the modified TWT slot duration. In some cases, the communication component 725 may be a processor. The processor may be coupled with memory and execute instructions stored in the memory that enable the processor to perform or facilitate the communication with a set of stations in a BSS according to a TWT slot duration as discussed herein.

Factor identifying component 730 may identify one or more congestion or interference factors for the BSS. In some cases, the factor identifying component 730 may be a processor. The processor may be coupled with memory and execute instructions stored in the memory that enable the processor to perform or facilitate identification of one or more congestion or interference factors as discussed herein.

TWT slot modification component 735 may modify the TWT slot duration based on the determined quantification score, modify the TWT slot duration based on the one or more congestion or interference factors, update the TWT slot duration to use to communicate with the set of stations based on the identified TWT slot duration value, select a reduced TWT slot duration, and select a TWT slot duration to be zero. In some cases, modifying the TWT slot duration based on the determined quantification score includes: identifying a TWT slot duration value based on a table of a set of TWT slot duration values corresponding to a set of quantification scores. In some cases, the TWT slot modification component 735 may be a processor. The processor may be coupled with memory and execute instructions stored in the memory that enable the processor to perform or facilitate modification of the TWT slot duration as discussed herein.

Transmitter 720 may transmit signals generated by other components of the device. In some examples, the transmitter 720 may be collocated with a receiver 710 in a transceiver module. For example, the transmitter 720 may be an example of aspects of the transceiver 935 described with reference to FIG. 9. The transmitter 720 may include a single antenna, or it may include a set of antennas.

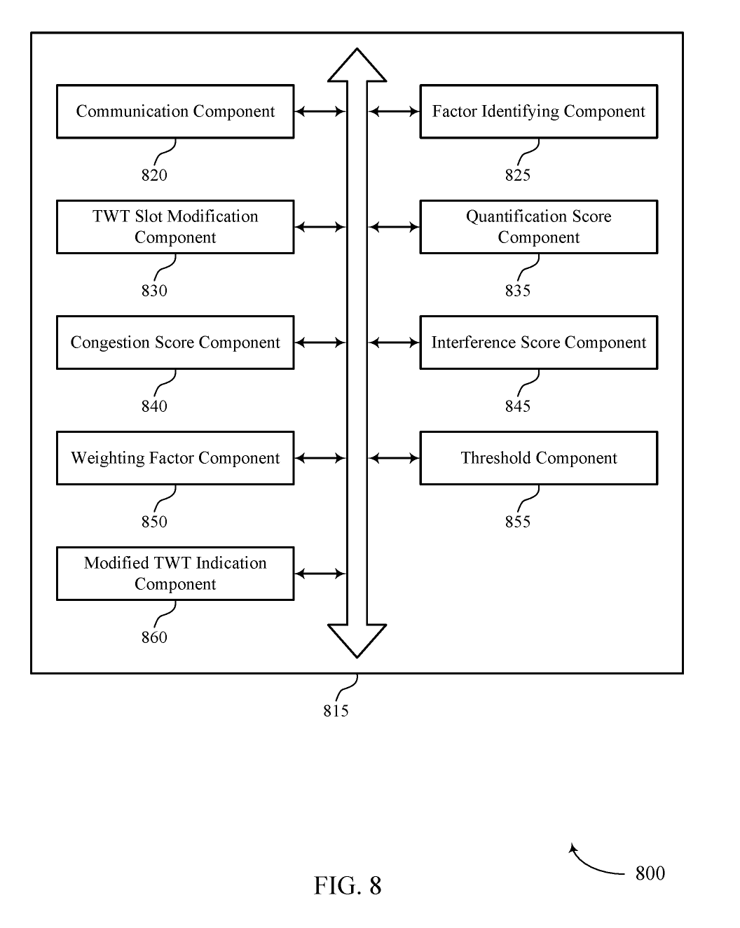

FIG. 8 shows a block diagram 800 of a TWT slot manager 815 that supports adaptive target wake time scheduling in accordance with various aspects of the present disclosure. The TWT slot manager 815 may be an example of aspects of a TWT slot manager 615, a TWT slot manager 715, or a TWT slot manager 915 described with reference to FIGS. 6, 7, and 9. The TWT slot manager 815 may include communication component 820, factor identifying component 825, TWT slot modification component 830, quantification score component 835, congestion score component 840, interference score component 845, weighting factor component 850, threshold component 855, and modified TWT indication component 860. Each of these modules may communicate, directly or indirectly, with one another (e.g., via one or more buses).

Communication component 820 may communicate with a set of stations in a BSS according to a TWT slot duration, communicate with the set of stations in the BSS according to the modified TWT slot duration, communicate with a second set of the set of stations in the BSS during the TWT SP and outside the one or more TWT slots, and receive data from the first set of the set of stations in the BSS during an uplink portion of the TWT slot. In some cases, communicating with the set of stations in the BSS according to the modified TWT slot duration includes: communicating with a first set of the set of stations in the BSS during one or more TWT slots of a TWT SP, the one or more TWT slots having the modified TWT slot duration. In some cases, communicating with the set of stations in the BSS according to the modified TWT slot duration includes: transmitting data to a first set of the set of stations in the BSS during a downlink portion of a TWT slot having the modified TWT slot duration. In some cases, the communication component 820 may be a processor. The processor may be coupled with memory and execute instructions stored in the memory that enable the processor to perform or facilitate the communication with a set of stations in a BSS according to a TWT slot duration as discussed herein.

Factor identifying component 825 may identify one or more congestion or interference factors for the BSS. In some cases, the factor identifying component 825 may be a processor. The processor may be coupled with memory and execute instructions stored in the memory that enable the processor to perform or facilitate identification of one or more congestion or interference factors as discussed herein.

TWT slot modification component 830 may modify the TWT slot duration based on the determined quantification score, modify the TWT slot duration based on the one or more congestion or interference factors, update the TWT slot duration to use to communicate with the set of stations based on the identified TWT slot duration value, select a reduced TWT slot duration, and select a TWT slot duration to be zero. In some cases, modifying the TWT slot duration based on the determined quantification score includes: identifying a TWT slot duration value based on a table of a set of TWT slot duration values corresponding to a set of quantification scores. In some cases, the TWT slot modification component 830 may be a processor. The processor may be coupled with memory and execute instructions stored in the memory that enable the processor to perform or facilitate modification of the TWT slot duration as discussed herein.

Quantification score component 835 may determine the quantification score based on the congestion score and the interference score and determine the quantification score based on the first weighting factor applied to the congestion score and the second weighting factor applied to the interference score. In some cases, modifying the TWT slot duration based on the one or more congestion or interference factors includes: determining a quantification score based on the one or more congestion or interference factors. In some cases, the quantification score component 835 may be a processor. The processor may be coupled with memory and execute instructions stored in the memory that enable the processor to perform or facilitate determination of the quantification score as discussed herein.

Congestion score component 840 may determine a congestion score. In some cases, the congestion score component 840 may identify a congestion score based on at least one of the one or more congestion factors. In some cases, the one or more congestion factors include a first number of the set of stations of the BSS, a second number of the set of stations of the BSS supporting a TWT mode of operation, or a comparison between the first number and the second number, or a depth of transmit queue of the AP, or a number of transmit queue of the AP, or a combination thereof. In some cases, the congestion score component 840 may be a processor. The processor may be coupled with memory and execute instructions stored in the memory that enable the processor to perform or facilitate determination of the congestion score as discussed herein.

Interference score component 845 may identify an interference score based on at least one of the one or more interference factors. In some cases, the one or more interference factors include a received signal strength, or a number of detected stations of one or more OBSSs, or a number of detected access point of the one or more OBSSs, or a traffic level for the one or more OBSSs, or a number of stations of the one or more OBSSs that support a TWT mode of operation, or a combination thereof. In some cases, the interference score component 845 may be a processor. The processor may be coupled with memory and execute instructions stored in the memory that enable the processor to perform or facilitate determination of the interference score as discussed herein.

Weighting factor component 850 may identify a second weighting factor for the interference score. In some cases, determining the quantification score based on the one or more congestion or interference factors further includes: identifying a first weighting factor for the congestion score. In some cases, the weighting factor component 850 may be a processor. The processor may be coupled with memory and execute instructions stored in the memory that enable the processor to perform or facilitate identification of weighting factors as discussed herein.

Threshold component 855 may determine one or more thresholds relating to the quantification score. In some cases, modifying the TWT slot duration based on the determined quantification score includes: identifying that the determined quantification score exceeds a first threshold. In some cases, modifying the TWT slot duration based on the determined quantification score includes: identifying that the determined quantification score exceeds a second threshold. In some cases, the threshold component 855 may be a processor. The processor may be coupled with memory and execute instructions stored in the memory that enable the processor to perform or facilitate determination of one or more thresholds as discussed herein.

Modified TWT indication component 860 may transmit an indication of the modified TWT slot duration to the set of stations of the BSS and transmit the indication of the modified TWT slot duration in a management frame during a TWT SP. In some cases, the modified TWT indication component 860 may be a processor. The processor may be coupled with memory and execute instructions stored in the memory that enable the processor to perform or facilitate transmission of indication of modified TWT as discussed herein.

FIG. 9 shows a diagram of a system 900 including a device 905 that supports adaptive target wake time scheduling in accordance with various aspects of the present disclosure. Device 905 may be an example of or include the components of wireless device 605, wireless device 705, or an AP 105 as described above, e.g., with reference to FIGS. 1, 6 and 7. Device 905 may include components for bi-directional voice and data communications including components for transmitting and receiving communications, including TWT slot manager 915, processor 920, memory 925, software 930, transceiver 935, antenna 940, and I/O controller 945. These components may be in electronic communication via one or more busses (e.g., bus 910).

Processor 920 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, processor 920 may be configured to operate a memory array using a memory controller. In other cases, a memory controller may be integrated into processor 920. Processor 920 may be configured to execute computer-readable instructions stored in a memory to perform various functions (e.g., functions or tasks supporting adaptive target wake time scheduling).

Memory 925 may include random access memory (RAM) and read only memory (ROM). The memory 925 may store computer-readable, computer-executable software 930 including instructions that, when executed, cause the processor to perform various functions described herein. In some cases, the memory 925 may contain, among other things, a basic input/output system (BIOS) which may control basic hardware and/or software operation such as the interaction with peripheral components or devices.

Software 930 may include code to implement aspects of the present disclosure, including code to support adaptive target wake time scheduling. Software 930 may be stored in a non-transitory computer-readable medium such as system memory or other memory. In some cases, the software 930 may not be directly executable by the processor but may cause a computer (e.g., when compiled and executed) to perform functions described herein.

Transceiver 935 may communicate bi-directionally, via one or more antennas, wired, or wireless links as described above. For example, the transceiver 935 may represent a wireless transceiver and may communicate bi-directionally with another wireless transceiver. The transceiver 935 may also include a modem to modulate the packets and provide the modulated packets to the antennas for transmission, and to demodulate packets received from the antennas.

In some cases, the wireless device may include a single antenna 940. However, in some cases the device may have more than one antenna 940, which may be capable of concurrently transmitting or receiving multiple wireless transmissions.

I/O controller 945 may manage input and output signals for device 905. I/O controller 945 may also manage peripherals not integrated into device 905. In some cases, I/O controller 945 may represent a physical connection or port to an external peripheral. In some cases, I/O controller 945 may utilize an operating system such as iOS®, ANDROID®, MS-DOS®, MS-WINDOWS®, OS/2®, UNIX®, LINUX®, or another known operating system. In other cases, I/O controller 945 may represent or interact with a modem, a keyboard, a mouse, a touchscreen, or a similar device. In some cases, I/O controller 945 may be implemented as part of a processor. In some cases, a user may interact with device 905 via I/O controller 945 or via hardware components controlled by I/O controller 945.

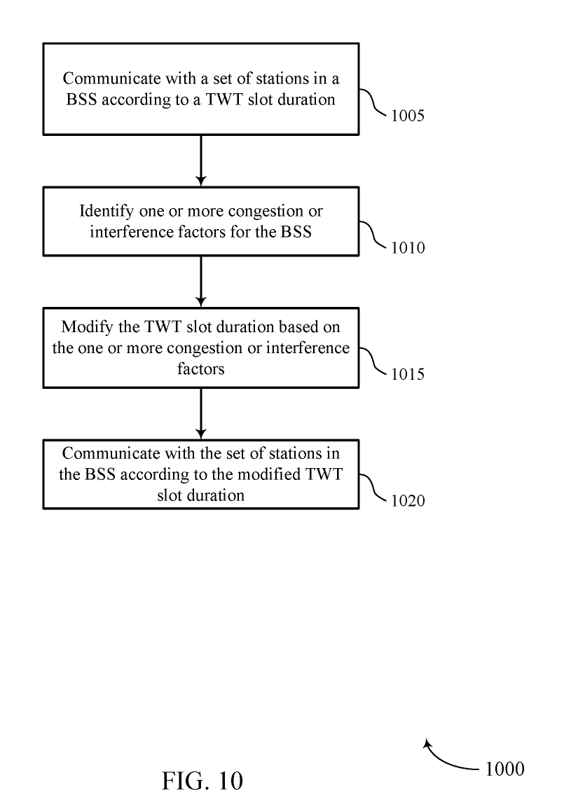

FIG. 10 shows a flowchart illustrating a method 1000 for adaptive target wake time scheduling in accordance with various aspects of the present disclosure. The operations of method 1000 may be implemented by an AP 105 or its components as described herein. For example, the operations of method 1000 may be performed by a TWT slot manager as described with reference to FIGS. 6 through 9. In some examples, an AP 105 may execute a set of codes to control the functional elements of the device to perform the functions described below. Additionally or alternatively, the AP 105 may perform aspects of the functions described below using special-purpose hardware.

At block 1005 the AP 105 may communicate with a plurality of stations in a BSS according to a TWT slot duration. The operations of block 1005 may be performed according to the methods described with reference to FIGS. 1 through 5. In certain examples, aspects of the operations of block 1005 may be performed by a communication component as described with reference to FIGS. 6 through 9.

At block 1010 the AP 105 may identify one or more congestion or interference factors for the BSS. The operations of block 1010 may be performed according to the methods described with reference to FIGS. 1 through 5. In certain examples, aspects of the operations of block 1010 may be performed by a factor identifying component as described with reference to FIGS. 6 through 9.

At block 1015 the AP 105 may modify the TWT slot duration based at least in part on the one or more congestion or interference factors. The operations of block 1015 may be performed according to the methods described with reference to FIGS. 1 through 5. In certain examples, aspects of the operations of block 1015 may be performed by a TWT slot modification component as described with reference to FIGS. 6 through 9.

At block 1020 the AP 105 may communicate with the plurality of stations in the BSS according to the modified TWT slot duration. The operations of block 1020 may be performed according to the methods described with reference to FIGS. 1 through 5. In certain examples, aspects of the operations of block 1020 may be performed by a communication component as described with reference to FIGS. 6 through 9.

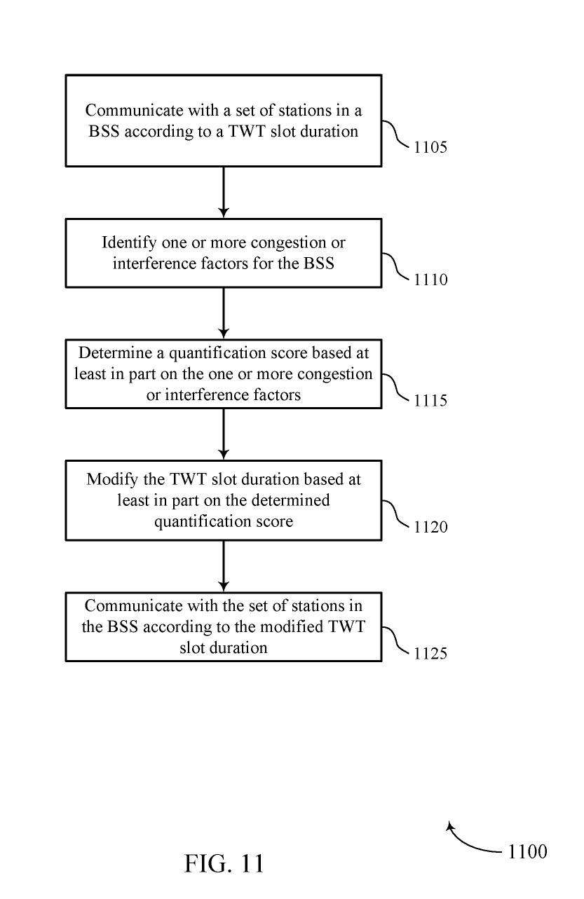

FIG. 11 shows a flowchart illustrating a method 1100 for adaptive target wake time scheduling in accordance with various aspects of the present disclosure. The operations of method 1100 may be implemented by an AP 105 or its components as described herein. For example, the operations of method 1100 may be performed by a TWT slot manager as described with reference to FIGS. 6 through 9. In some examples, an AP 105 may execute a set of codes to control the functional elements of the device to perform the functions described below. Additionally or alternatively, the AP 105 may perform aspects of the functions described below using special-purpose hardware.

At block 1105 the AP 105 may communicate with a plurality of stations in a BSS according to a TWT slot duration. The operations of block 1105 may be performed according to the methods described with reference to FIGS. 1 through 5. In certain examples, aspects of the operations of block 1105 may be performed by a communication component as described with reference to FIGS. 6 through 9.

At block 1110 the AP 105 may identify one or more congestion or interference factors for the BSS. The operations of block 1110 may be performed according to the methods described with reference to FIGS. 1 through 5. In certain examples, aspects of the operations of block 1110 may be performed by a factor identifying component as described with reference to FIGS. 6 through 9.

At block 1115 the AP 105 may determine a quantification score based at least in part on the one or more congestion or interference factors. The operations of block 1115 may be performed according to the methods described with reference to FIGS. 1 through 5. In certain examples, aspects of the operations of block 1115 may be performed by a quantification score component as described with reference to FIGS. 6 through 9. In some cases, modifying the TWT slot duration based at least in part on the one or more congestion or interference factors comprises: determining a quantification score based at least in part on the one or more congestion or interference factors.

At block 1120 the AP 105 may modify the TWT slot duration based at least in part on the determined quantification score. The operations of block 1120 may be performed according to the methods described with reference to FIGS. 1 through 5. In certain examples, aspects of the operations of block 1120 may be performed by a TWT slot modification component as described with reference to FIGS. 6 through 9.

At block 1125 the AP 105 may communicate with the plurality of stations in the BSS according to the modified TWT slot duration. The operations of block 1125 may be performed according to the methods described with reference to FIGS. 1 through 5. In certain examples, aspects of the operations of block 1125 may be performed by a communication component as described with reference to FIGS. 6 through 9.

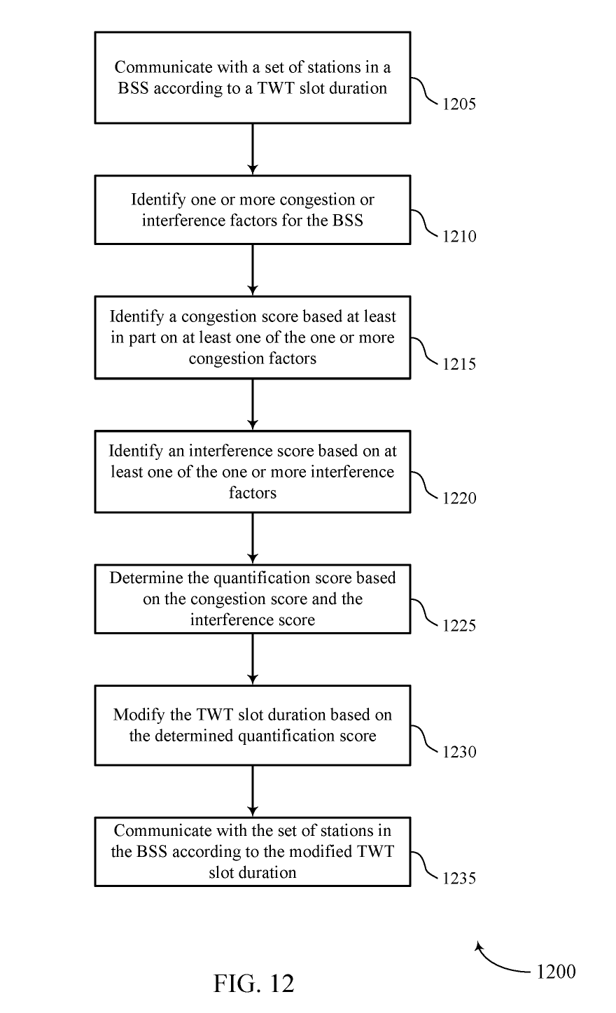

FIG. 12 shows a flowchart illustrating a method 1200 for adaptive target wake time scheduling in accordance with various aspects of the present disclosure. The operations of method 1200 may be implemented by an AP 105 or its components as described herein. For example, the operations of method 1200 may be performed by a TWT slot manager as described with reference to FIGS. 6 through 9. In some examples, an AP 105 may execute a set of codes to control the functional elements of the device to perform the functions described below. Additionally or alternatively, the AP 105 may perform aspects of the functions described below using special-purpose hardware.

At block 1205 the AP 105 may communicate with a plurality of stations in a BSS according to a TWT slot duration. The operations of block 1205 may be performed according to the methods described with reference to FIGS. 1 through 5. In certain examples, aspects of the operations of block 1205 may be performed by a communication component as described with reference to FIGS. 6 through 9.

At block 1210 the AP 105 may identify one or more congestion or interference factors for the BSS. The operations of block 1210 may be performed according to the methods described with reference to FIGS. 1 through 5. In certain examples, aspects of the operations of block 1210 may be performed by a factor identifying component as described with reference to FIGS. 6 through 9.

At block 1215 the AP 105 may identify a congestion score based at least in part on at least one of the one or more congestion factors. The operations of block 1215 may be performed according to the methods described with reference to FIGS. 1 through 5. In certain examples, aspects of the operations of block 1215 may be performed by a congestion score component as described with reference to FIGS. 6 through 9.

At block 1220 the AP 105 may identify an interference score based at least in part on at least one of the one or more interference factors. The operations of block 1220 may be performed according to the methods described with reference to FIGS. 1 through 5. In certain examples, aspects of the operations of block 1220 may be performed by an interference score component as described with reference to FIGS. 6 through 9.

At block 1225 the AP 105 may determine the quantification score based at least in part on the congestion score and the interference score. The operations of block 1225 may be performed according to the methods described with reference to FIGS. 1 through 5. In certain examples, aspects of the operations of block 1225 may be performed by a quantification score component as described with reference to FIGS. 6 through 9.

At block 1230 the AP 105 may modify the TWT slot duration based at least in part on the determined quantification score. The operations of block 1230 may be performed according to the methods described with reference to FIGS. 1 through 5. In certain examples, aspects of the operations of block 1230 may be performed by a TWT slot modification component as described with reference to FIGS. 6 through 9.

At block 1235 the AP 105 may communicate with the plurality of stations in the BSS according to the modified TWT slot duration. The operations of block 1235 may be performed according to the methods described with reference to FIGS. 1 through 5. In certain examples, aspects of the operations of block 1235 may be performed by a communication component as described with reference to FIGS. 6 through 9.

It should be noted that the methods described above describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, WLAN 100 and wireless communications system 200 of FIGS. 1 and 2—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. An apparatus for wireless communication, in a system comprising:
a memory that stores instructions; and
a processor coupled with the memory, wherein the processor and the memory are configured to:
communicate with a plurality of stations in a basic service set (BSS) according to a target wakeup time (TWT) slot duration;
identify one or more congestion or interference factors for the BSS;
modify the TWT slot duration based at least in part on the one or more congestion or interference factors; and
communicate with the plurality of stations in the BSS according to the modified TWT slot duration.

2. The apparatus of claim 1, wherein the processor and the memory are configured to modify the TWT slot duration based at least in part on the one or more congestion or interference factors by being configured to:
determine a quantification score based at least in part on the one or more congestion or interference factors; and
modify the TWT slot duration based at least in part on the determined quantification score.

3. The apparatus of claim 2, wherein the processor and the memory are configured to determine the quantification score based at least in part on the one or more congestion or interference factors by being configured to:
identify a congestion score based at least in part on at least one of the one or more congestion factors;
identify an interference score based at least in part on at least one of the one or more interference factors; and
determine the quantification score based at least in part on the congestion score and the interference score.

4. The apparatus of claim 3, wherein the processor and the memory are configured to determine the quantification score based at least in part on the congestion score and the interference score by being configured to:
identify a first weighting factor for the congestion score;
identify a second weighting factor for the interference score; and
determine the quantification score based at least in part on the first weighting factor applied to the congestion score and the second weighting factor applied to the interference score.

5. The apparatus of claim 2, wherein the processor and the memory are configured to modify the TWT slot duration based at least in part on the determined quantification score by being configured to:
identify a TWT slot duration value based at least in part on a table of a plurality of TWT slot duration values corresponding to a plurality of quantification scores; and
update the TWT slot duration to use to communicate with the plurality of stations based at least in part on the identified TWT slot duration value.

6. The apparatus of claim 2, wherein the processor and the memory are configured to modify the TWT slot duration based at least in part on the determined quantification score by being configured to:
identify that the determined quantification score exceeds a first threshold; and
select a reduced TWT slot duration.

7. The apparatus of claim 2, wherein the processor and the memory are configured to modify the TWT slot duration based at least in part on the determined quantification score by being configured to:
identify that the determined quantification score exceeds a second threshold; and
select a TWT slot duration to be zero.

8. The apparatus of claim 1, wherein the one or more congestion factors comprise a first number of the plurality of stations of the BSS, a second number of the plurality of stations of the BSS supporting a TWT mode of operation, or a comparison between the first number and the second number, or a depth of transmit queue of the AP, or a number of transmit queue of the AP, or a combination thereof.

9. The apparatus of claim 1, wherein the one or more interference factors comprise a received signal strength, or a number of detected stations of one or more other BSSs (OBSSs), or a number of detected access point of the one or more OBSSs, or a traffic level for the one or more OBSSs, or a number of stations of the one or more OBSSs that support a TWT mode of operation, or a combination thereof.

10. The apparatus of claim 1, wherein the processor and the memory are further configured to:
transmit an indication of the modified TWT slot duration to the plurality of stations of the BSS.

11. The apparatus of claim 10, wherein the processor and the memory are further configured to:
transmit the indication of the modified TWT slot duration in a management frame during a TWT service period.

12. The apparatus of claim 1, wherein the processor and the memory are configured to communicate with the plurality of stations in the BSS according to the modified TWT slot duration by being configured to:
communicate with a first set of the plurality of stations in the BSS during one or more TWT slots of a TWT service period, the one or more TWT slots having the modified TWT slot duration; and
communicate with a second set of the plurality of stations in the BSS during the TWT service period and outside the one or more TWT slots.

13. The apparatus of claim 1, wherein the processor and the memory are configured to communicate with the plurality of stations in the BSS according to the modified TWT slot duration by being configured to:
transmit data to a first set of the plurality of stations in the BSS during a downlink portion of a TWT slot having the modified TWT slot duration; and
receive data from the first set of the plurality of stations in the BSS during an uplink portion of the TWT slot.

14. A method for wireless communication, comprising:
communicating with a plurality of stations in a basic service set (BSS) according to a target wakeup time (TWT) slot duration;
identifying one or more congestion or interference factors for the BSS;
modifying the TWT slot duration based at least in part on the one or more congestion or interference factors; and
communicating with the plurality of stations in the BSS according to the modified TWT slot duration.

15. The method of claim 14, wherein modifying the TWT slot duration based at least in part on the one or more congestion or interference factors comprises:
determining a quantification score based at least in part on the one or more congestion or interference factors; and
modifying the TWT slot duration based at least in part on the determined quantification score.

16. The method of claim 15, wherein determining the quantification score based at least in part on the one or more congestion or interference factors comprises:
identifying a congestion score based at least in part on at least one of the one or more congestion factors;
identifying an interference score based at least in part on at least one of the one or more interference factors; and
determining the quantification score based at least in part on the congestion score and the interference score.

17. The method of claim 16, wherein determining the quantification score based at least in part on the one or more congestion or interference factors further comprises:
identifying a first weighting factor for the congestion score;
identifying a second weighting factor for the interference score; and
determining the quantification score based at least in part on the first weighting factor applied to the congestion score and the second weighting factor applied to the interference score.

18. The method of claim 15, wherein modifying the TWT slot duration based at least in part on the determined quantification score comprises:
identifying a TWT slot duration value based at least in part on a table of a plurality of TWT slot duration values corresponding to a plurality of quantification scores; and
updating the TWT slot duration to use to communicate with the plurality of stations based at least in part on the identified TWT slot duration value.

19. The method of claim 15, wherein modifying the TWT slot duration based at least in part on the determined quantification score comprises:
identifying that the determined quantification score exceeds a first threshold; and
selecting a reduced TWT slot duration.

20. The method of claim 15, wherein:
modifying the TWT slot duration based at least in part on the determined quantification score comprises: identifying that the determined quantification score exceeds a second threshold; and
the method further comprising selecting a TWT slot duration to be zero.

21. The method of claim 14, wherein the one or more congestion factors comprise a first number of the plurality of stations of the BSS, a second number of the plurality of stations of the BSS supporting a TWT mode of operation, or a comparison between the first number and the second number, or a depth of transmit queue of the AP, or a number of transmit queue of the AP, or a combination thereof.

22. The method of claim 14, wherein the one or more interference factors comprise a received signal strength, or a number of detected stations of one or more other BSSs (OBSSs), or a number of detected access point of the one or more OBSSs, or a traffic level for the one or more OBSSs, or a number of stations of the one or more OBSSs that support a TWT mode of operation, or a combination thereof.

23. The method of claim 14, further comprising:
transmitting an indication of the modified TWT slot duration to the plurality of stations of the BSS.

24. The method of claim 23, further comprising:
transmitting the indication of the modified TWT slot duration in a management frame during a TWT service period.

25. The method of claim 14, wherein communicating with the plurality of stations in the BSS according to the modified TWT slot duration comprises:
communicating with a first set of the plurality of stations in the BSS during one or more TWT slots of a TWT service period, the one or more TWT slots having the modified TWT slot duration; and
communicating with a second set of the plurality of stations in the BSS during the TWT service period and outside the one or more TWT slots.

26. The method of claim 14, wherein communicating with the plurality of stations in the BSS according to the modified TWT slot duration comprises:
transmitting data to a first set of the plurality of stations in the BSS during a downlink portion of a TWT slot having the modified TWT slot duration; and
receiving data from the first set of the plurality of stations in the BSS during an uplink portion of the TWT slot.

27. An apparatus for wireless communication, comprising:
means for communicating with a plurality of stations in a basic service set (BSS) according to a target wakeup time (TWT) slot duration;
means for identifying one or more congestion or interference factors for the BSS;
means for modifying the TWT slot duration based at least in part on the one or more congestion or interference factors; and
means for communicating with the plurality of stations in the BSS according to the modified TWT slot duration.

28. The apparatus of claim 27, wherein the means for modifying the TWT slot duration based at least in part on the one or more congestion or interference factors comprises:
means for determining a quantification score based at least in part on the one or more congestion or interference factors; and
means for modifying the TWT slot duration based at least in part on the determined quantification score.

29. The apparatus of claim 28, wherein the means for determining the quantification score based at least in part on the one or more congestion or interference factors comprises:
means for identifying a congestion score based at least in part on at least one of the one or more congestion factors;
means for identifying an interference score based at least in part on at least one of the one or more interference factors; and
means for determining the quantification score based at least in part on the congestion score and the interference score.

30. A non-transitory computer readable medium storing code for wireless communication, the code comprising instructions executable by a processor to:
communicate with a plurality of stations in a basic service set (BSS) according to a target wakeup time (TWT) slot duration;
identify one or more congestion or interference factors for the BSS;
modify the TWT slot duration based at least in part on the one or more congestion or interference factors; and
communicate with the plurality of stations in the BSS according to the modified TWT slot duration.
